(19) United States
(12) Patent Application Publication
(10) Pub. No.: US 2019/0251625 A1
(43) Pub. Date: Aug. 15, 2019

(54) SYSTEM AND METHOD FOR AUTOMATED GENERATION AND EXECUTION OF INSTRUMENT TRANSACTIONS

(71) Applicant: John Charles Brooke BISCOE, Toronto (CA)

(72) Inventor: John Charles Brooke BISCOE, Toronto (CA)

(21) Appl. No.: 15/892,813

(22) Filed: Feb. 9, 2018

(51) Int. Cl. G06Q 40/04

(52) U.S. Cl. CPC G06Q 40/04

(57) ABSTRACT

An instrument transaction system for generating and executing an instrument transaction for a target instrument between an instrument transaction seller and an instrument transaction purchaser, the target instrument having an instrument value, the instrument value being unknown before a release date and the instrument value being known after the release date, the system comprising: a computer processor coupled to a memory, wherein the computer processor is programmed to process an instrument transaction by: obtaining a first set of rules that define as an output the instrument transaction as a function of the target instrument of a target entity and a set of transaction features, the instrument transaction comprising a set of settlement rules and execution rules and the transaction features comprising a start date, the instrument value, and a release date wherein the start date is the date preceding the release date and the release date is the date at which the instrument value is available; obtaining the target instrument and the set of transaction features; generating the instrument transaction by evaluating the target instrument and the set of transaction features against the first set of rules; and executing the instrument transaction by: receiving the instrument value; determining a settlement value by evaluating the instrument value against the set of settlement rules of the instrument transaction; and sending the settlement value based on the execution rules of the instrument transaction.

This application relates generally to the automation of generating and executing instrument transactions over a network.

### BACKGROUND

A derivative is an instrument whose price is determined by underlying value of another instrument or thing. Common examples include stock prices, bond prices, interest rates, exchange rates and commodities.

There are numerous types of derivatives that are used today. The following a few examples. This list is in no way exhaustive and should not be treated as such. A future or forward is contract which assigns an obligation to buy to one party and an obligation to sell to another party an asset at a fixed date and fixed price in the future. An option, gives the option buyer, the right, but not the obligation, to buy or sell an asset at some date in the future. For this right, the option buyer pays a premium to the option seller. A swap is the obligation to make/receive a series of payments over some regular interval over a period based on the price of an underlying asset. This is essentially a series of futures contracts negotiated at the start.

Since derivatives became more popular in the 1970's, their uses have grown along with their popularity. Derivatives are often used by institutions and individuals to reduce the risk of an investment or asset. This can be achieved by purchasing a derivative that has the opposite exposure to the asset that the institution of individual holds (such as selling a future when the institution/individual owns the underlying asset). Derivatives are also used by speculators to gain exposure to an underlying asset. Speculators may use derivatives to gain a leverage exposure to an asset, to purchase an asset at a certain price, to generate income or to gain exposure in a way that is more economically advantageous to them. Finally, derivatives are used to obtain additionally information about an assets. For example, option prices are used to calculate implied volatility of stocks, bonds and commodities and future prices are used to determine the markets expectations of the future price of an asset.

Derivatives are either traded over-the-counter (“OTC”) or on an exchange. Derivatives traded on an exchange have standardized terms and daily or frequent margin requirements. OTC derivatives are privately negotiated between individuals or institutions. Their terms and margin requirements are not standardized.

Although derivatives are widely available on numerous underlying assets that can be used by users to hedge and speculate on certain risk factors there is currently no way to directly hedge and/or speculate on actual accounting performance which is determined by a number of factors including management strategy, budget policy, consumer/business sentiment, broad economic conditions and/or demand for product to name a few.

### SUMMARY

Disadvantages with current instrument transaction generation and execution systems are that they are not able to provide instrument transactions that can be used to directly hedge and/or speculate on actual accounting performance of a target entity. The ability to generate and execute instrument transactions with variable or unknown key dates and time period is lacking. It is an object of the present invention to provide an instrument transaction generation and execution system to obviate or mitigate at least some of this, and other disadvantages.

A first aspect provided is an instrument transaction system for generating and executing an instrument transaction for a target instrument between an instrument transaction seller and an instrument transaction purchaser, the target instrument having an instrument value, the instrument value being unknown before a release date and the instrument value being known after the release date, the system comprising: a computer processor coupled to a memory, wherein the computer processor is programmed to process an instrument transaction by: obtaining a first set of rules that define as an output the instrument transaction as a function of the target instrument of a target entity and a set of transaction features, the instrument transaction comprising a set of settlement rules and execution rules and the transaction features comprising a start date, the instrument value, and a release date wherein the start date is the date preceding the release date and the release date is the date at which the instrument value is available; obtaining the target instrument and the set of transaction features; generating the instrument transaction by evaluating the target instrument and the set of transaction features against the first set of rules; and executing the instrument transaction by: receiving the instrument value; determining a settlement value by evaluating the instrument value against the set of settlement rules of the instrument transaction; and sending the settlement value based on the execution rules of the instrument transaction.

A second aspect provided is an instrument transaction generation and execution system comprising: a non-transitory computer readable storage medium with an executable instrument transaction generation and execution application stored thereon, the instrument transaction application configured for processing an instrument transaction update request associated with a target entity computer system over a communications network, wherein the instrument transaction application instructs a computer processor to perform the steps of: (a) receiving update information from the target entity, (b) identifying a subscribing party, the subscribing party having requested to receive the update information from the system, (c) sending output to the subscribing party, the output for presentation to the subscribing party on a user interface of a computer system of the subscribing party running a client application of the instrument transaction application in order to communicate the update information, and (d) receiving from the subscribing party, confirmation of the receipt of the update information.

A further aspect provided is an instrument transaction generation and execution system comprising a non-transitory computer readable storage medium with an executable instrument transaction generation and execution application stored thereon, the instrument transaction application configured for processing an instrument transaction confirmation associated with a target entity computer system, a confirming party computer system, and a receiving party computer system over a communications network, wherein the instrument transaction application instructs a computer processor to perform the steps of: (a) receiving update data from the target entity, (b) determining confirmation information based on the update data, (c) identifying a confirming party, the confirming party required to confirm the confirmation information, (d) sending output to the confirming party, the output for presentation to the confirming party on a user interface of a computer system of the confirming party running a client application of the instrument transaction application in order to communicate the confirmation information, (e) receiving from the confirming party, confirmation of the acceptance of the confirmation information, (f) generating a notification of the received confirmation, (g) identifying a receiving party, the receiving party to receive the notification, and (h) sending a second output to the receiving party, the second output for presentation to the receiving party on a user interface of a computer system of the receiving party running a second client application of the instrument transaction application in order to communicate the notification.

### BRIEF DESCRIPTION OF THE DRAWINGS

These and other features will become more apparent in the following detailed description in which reference is made to the appended drawings wherein:

FIG. 1 shows an exemplary instrument transaction service;

FIG. 2 shows an example instrument transaction generation and execution system;

FIG. 3 illustrates an exemplary sequence of operations of the instrument transaction service system.

FIG. 4 illustrates the time periods defined by the dates of a set of transaction features.

### DETAILED DESCRIPTION

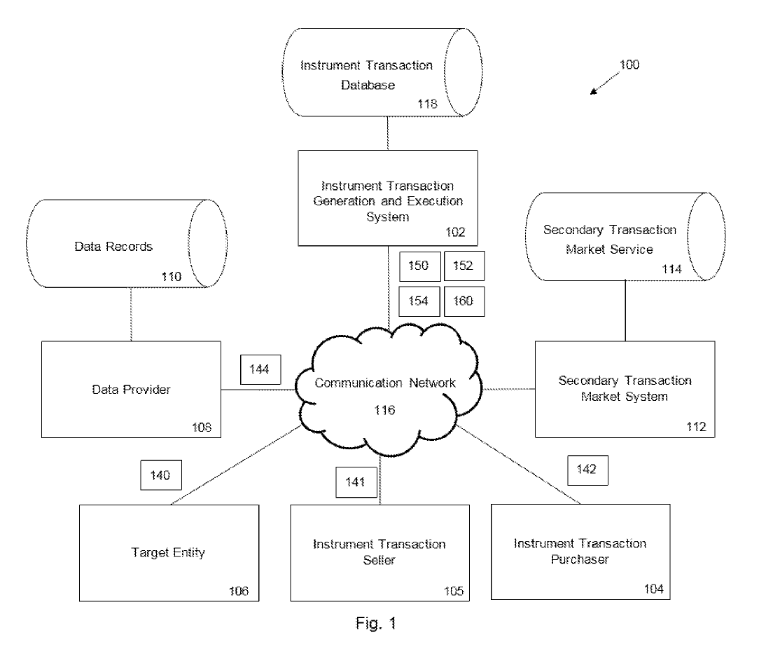

With reference to FIG. 1, the instrument banking service system 100 comprises an instrument transaction generation and execution system 102 to generate and execute an instrument transaction 160. The instrument transaction generation and execution system 102 is connected to an instrument transaction database 118 which stores instrument transactions 160. The instrument transaction database 118 can be a component of the instrument transaction generation and execution system 102, or alternatively can be locally or remotely connected to the instrument transaction generation and execution system 102 via a communications network 116. The instrument transaction generation and execution system 102 is connected to a computer system of a target entity 106 via a communications network 116 (e.g. the internet). The target entity 106 can send to the instrument transaction generation and execution system 102, via the communications network 116, information regarding a target instrument 140 of the target entity 106 which operates as the underlying asset in an instrument transaction 160 generated and executed by the instrument transaction generation and execution system 102. Examples of such information include the value of the target instrument, the expected date the value of the target instrument will be reported, past values of the target instrument and/or a predicted value of the target instrument.

The instrument transaction generation and execution system 102 can receive from an instrument transaction seller 105 an instrument transaction generation request 141. The instrument transaction generation and execution system 102 is connected to a computer system of the instrument transaction seller 105 via the communications network 116. The instrument transaction seller 105 sends to the instrument transaction generation and execution system 102, via the communications network 116, the instrument transaction generation request 141 which identifies a target instrument of the target entity 106 and a set of features of an instrument transaction 160 which the instrument transaction seller 105 wishes to generate and sell via the instrument transaction generation and execution system 102.

The instrument transaction generation and execution system 102 can receive from an instrument transaction purchaser 104 an instrument transaction purchase request 142. The instrument transaction generation and execution system 102 is connected to a computer system of the instrument transaction purchaser 104 via the communications network 116. The instrument transaction purchaser 104 sends to the instrument transaction generation and execution system 102, via the communications network 116, the instrument transaction purchase request 142 which identifies a target instrument transaction 160 that the instrument transaction purchaser 104 wishes to purchase. The instrument transaction generation and execution system 102 can facilitate the purchase upon receipt of the instrument transaction purchase request 142, or can request from the instrument transaction seller 105 confirmation that they wish to sell the instrument transaction 160 to the instrument transaction purchaser 104.

The target entity 106 can be one of the instrument transaction purchaser 104 or instrument transaction seller 105. Alternatively, both the instrument transaction purchaser 104 and the instrument transaction seller 105 can be third parties.

The instrument transaction generation and execution system 102 can obtain historical data 144 regarding the target instrument from a third party data provider 108. The instrument transaction generation and execution system 102 is connected to a computer system of the third party data provider 108, which comprises data records 110. These data records 110 can comprise past values of the target instrument of the target entity 106 and other historical data relating to the target entity 106. The instrument transaction generation and execution system 102 can use this historical data 144 in the generation of an instrument transaction and/or the generation of a premium value 154. While only one third party data provide 108 is shown, it is understood that the instrument transaction generation and execution system 102 can connect to any number of third party data providers 108.

The instrument transaction generation and execution system 102 can also obtain historical instrument transactions stored in the instrument transaction database 118. The instrument transaction generation and execution system 102 can use these historical instrument transactions in the pricing of new instrument transactions 160 and the determination of premium values 154.

Based upon the target instrument, the transaction features, and the historical data 144, the instrument transaction generation and execution system 102 generates an instrument transaction 160 to be executed. The instrument transaction generation and execution system 102 can store the instrument transaction 160 in the instrument transaction database 118 prior to execution of the instrument transaction 160.

The instrument transaction generation and execution system 102 can execute the payment of a premium of the instrument transaction 160 by determining a premium value 154 and directing payment to the instrument transaction seller 105. The instrument transaction generation and execution system 102 sends the premium value 154 to the instrument transaction seller 105 and the instrument transaction purchaser 104, to enable the instrument transaction seller 105 and the instrument transaction purchaser 104 to execute the payment of the premium value 154.

In other words, a target entity 106 may not be part of an instrument transaction 160. It is possible that the instrument transaction generation and execution system 102 could sell a derivative (e.g. the instrument transaction 160) to a purchaser (e.g. the instrument transaction purchaser 104) or could buy a derivative (e.g. the instrument transaction 160) from a seller (e.g. the instrument transaction seller 105).

In one embodiment, the instrument transaction generation and execution system 102 can execute the payment of the premium of the instrument transaction 160 by facilitating the payment of the premium value 154 from the instrument transaction purchaser 104 to the instrument transaction seller 105. The instrument transaction generation and execution system 102 can receive payment of the premium value 154 from the instrument transaction purchaser 104 and send the payment of the premium value 154 to the instrument transaction seller 105. The collection and payment of the premium value 154 can be accomplished by the instrument transaction generation and execution system 102 via transactions executed with third party computer systems over the communication network 116. Alternatively, the collection and payment of the settlement value 150 can be accomplished via the transfer of funds between accounts maintained on the instrument transaction generation and execution system 102.

The instrument transaction generation and execution system 102 can execute the settlement of the instrument transaction 160 by receiving, on or after the release date, the target instrument value of the target instrument as of the valuation date. The instrument value can be received from the target entity 106 or from a third party. The instrument transaction generation and execution system 102 then evaluates the target instrument value against the instrument transaction 160. The instrument transaction generation and execution system 102 determines whether, in order to settle the instrument transaction, payment of the settlement value 150 is to be made to the instrument transaction seller 105 or to the instrument transaction purchaser 104. The instrument transaction generation and execution system then sends the settlement value 150 to the instrument transaction seller 105 and the instrument transaction purchaser 104, to enable them to execute the payment of the settlement value 150. In other words, the instrument transaction 160 cannot be settled and closed before the valuation date because the value of the underlying asset is unknown by the parties to the instrument transaction.

In one embodiment, the instrument transaction generation and execution system 102 can execute the settlement of the instrument transaction 160 by collecting the settlement value 150 from the instrument transaction seller 105 or the instrument transaction purchaser 104 and paying the settlement value 150 to the instrument transaction seller 105 or the instrument transaction purchaser 104. The collection and payment of the settlement value 150 can be accomplished by the instrument transaction generation and execution system 102 via transactions executed with third party computer systems over the communication network 116. Alternatively, the collection and payment of the settlement value 150 can be accomplished via the transfer of funds between accounts maintained on the instrument transaction generation and execution system 102.

The instrument transaction generation and execution system 102 can execute interim settlements of the instrument transaction 160 so that a party can exchange or post collateral before the maturity of the instrument transaction 160. For each interim settlement to be executed, the instrument transaction generation and execution system 102 determines the interim settlement value 152 and whether payment of the interim settlement value 152 is to be made to the instrument transaction seller 105 or to the instrument transaction purchaser 104. The instrument transaction generation and execution system 102 then sends the interim settlement value 152 to the instrument transaction seller 105 and the instrument transaction purchaser 104, to enable them to execute the payment of the interim settlement value 152. In other words, there can be an exchanging or posting of collateral before the maturity date. The execution of a payment of interim settlement values 152 can occur at any time between the date an instrument transaction is generated (i.e. the generation date) and the maturity date. In some cases and “up front” exchange of collateral may be required.

In one embodiment, the instrument transaction generation and execution system 102 can execute the interim settlements of the instrument transaction 160 by facilitating the payment of the interim settlement value 152 between the instrument transaction seller 105 and the instrument transaction purchaser. The instrument transaction generation and execution system 102 can receive payment of the interim settlement value 152 from the instrument transaction purchaser 104 and send the payment of the interim settlement value 152 to the instrument transaction seller 105. The collection and payment of the interim settlement values 152 can be accomplished by the instrument transaction generation and execution system 102 via transactions executed with third party computer systems over the communication network 116. Alternatively, the collection and payment of the interim settlement value 152 can be accomplished via the transfer of funds between accounts maintained on the instrument transaction generation and execution system 102.

The means of executing the interim settlement can be determined in a manner agreed upon by the parties to the instrument transaction 160 at the generation of the instrument transaction 160. For example, the parties can use analyst consensus to mark the position, use the forecast of a third party provider, use updated management forecasts if available, use a variable which has a liquid market (such as the target entity's 106 stock price) to imply a change (e.g. if the stock price moves up by 10% the parties could agree that the derivative (i.e. the instrument transaction) has increase in value by 10%), or the parties could agree that there would be no interim exchange of collateral (which can happen with over the counter derivatives). If there was an interim exchange of collateral it can be netted at maturity. So if one party has posted too much collateral, they would get it back when the contract expired.

The interim settlement value 152 can be determined by any mechanism agreed to by the parties to the instrument transaction 150 (i.e. the instrument transaction seller 105 and/or the instrument transaction purchaser 104). The instrument transaction generation and execution system 102 can calculate an interim settlement value 152 based on a predictive interim instrument value. To determine the interim instrument value, the instrument transaction generation and execution system 102 can obtain predictive instrument value data from a third party data provider 108. Such data can include an analyst consensus value of the target instrument, a third party forecast, management forecasts of the target entity 106, and/or the value of a related instrument associated with the target entity 106 (e.g. the stock price of the target entity 106). The interim instrument value can be calculated based on a function of any combination of the predictive instrument value data. The interim settlement value 152 is calculated as a function of the strike or settlement price and the interim instrument value (i.e. the spot price).

Where an interim settlement value 152 has been calculated, the instrument transaction generation and execution system 102, when determining the settlement value 150, can modify the settlement value 150 based on interim settlement values 152. The instrument transaction generation and execution system 102 determines whether a party to the instrument transaction 150 exchanged or posted too much collateral as part of the execution of the interim settlements of the instrument transaction 160, and increases or decreases the settlement value 150 accordingly.

The instrument transaction generation and execution system 102 can alternatively generate an instrument 160 transaction and post it to a secondary transaction market service 114 via a computer of the secondary market system 112. The instrument transaction generation and execution system 102, after generating an instrument transaction 160 can connect to a secondary transaction market system 112 which operates a secondary transaction market service 114. The secondary transaction market service 114 facilitates the execution of the instrument transaction 160 and makes the instrument transaction 160 available for purchase by third party entities.

The set of transaction features of the instrument transaction 160 obtained by the instrument transaction generation and execution system 102 can include a generation date, a start date, a valuation date, a release date, a maturity date, and a settlement date. The generation date is the date at which the parties agree to enter into the instrument transaction 160. The start date is the date on which the valuation period begins. The valuation date is the date at which the value of the target instrument is determined in order to calculate the settlement value of the instrument transaction 160 (the valuation period). The release date is the date at which the value of the target instrument on the valuation date becomes known to entities other than the target entity 106. The maturity date is the date at which the settlement value 150 of instrument transaction 160 is calculated. The settlement date is the date at which the payment of the settlement value 150 of the instrument transaction 160 is executed. The set of transaction features can also include interim settlement dates. At these dates an interim settlement value 152 is calculated and the payment of that interim settlement value 152 is executed by the instrument transaction generation and execution system 102. The release date can be known by the target entity 106 and parties other than the target entity 106 at the generation date, the release date can be unknown by the target entity 106 and parties other than the target entity 106 at the generation date, or the release date can be known by the target entity 106 at the generation date and the release date can be unknown by parties other than the target entity 106 at the generation date.

In one embodiment, the transaction features define a multiple-period transaction (i.e. a swap). The transaction features defining a multiple-period transaction can include more than one valuation date, release date, maturity date and settlement date. In other words, it is understood that the parties to an instrument transaction 160 can negotiate multiple transactions with one or more valuation periods and settlement dates. Such transactions can be executed as a series of instrument transactions 160, or as a single instrument transaction 160 with multiple valuation periods and settlement dates. The more than one release date can be known by the target entity 106 and parties other than the target entity 106 at the generation date, the more than one release date can be unknown by the target entity 106 and parties other than the target entity 106 at the generation date, or the more than one release date can be known by the target entity 106 at the generation date and the more than one release date can be unknown by parties other than the target entity 106 at the generation date.

Where the release date is unknown at the generation date by the target entity 106 and the parties to the instrument transaction 160 that are not the target entity 106, the maturity date can also be unknown to the target entity 106 and the parties other than the target entity 106 at the generation date. In other words, a target entity 106 may not determine in advance of the generation date when it will release its financial statement for a given accounting period. As such, the parties to an instrument transaction 160 (i.e. the instrument transaction purchaser 104 and the instrument transaction seller 105) of a target instrument (e.g. a financial line item reported in the target entity's 106 financial statement) may not know the release date of the instrument transaction 160 at the time the instrument transaction 160 is generated. Therefore, the transaction period, defined by the start date and the release date can be undefined until the release date becomes known to the parties of the instrument transaction 160. While this could be possible, it would be fairly irregular. What is more likely is the scenario where a maturity date is set a sufficient amount of time after the valuation date to ensure the release date occurs before the maturity date. In such a case, the maturity date is known by the parties to the instrument transaction 160 at the generation date. In one embodiment, the settlement rules of the instrument transaction 160 can include an instruction for the instrument transaction generation and execution system 102 to wait until the financial statement and/or the value of the target instrument is provided to the instrument transaction generation and execution system 102, before executing the instrument transaction 160.

Preferably, the maturity date is known by the parties to the transaction before the instrument transaction 160 is generated. The maturity date is preferably set a sufficient amount of time after the valuation date to allow for the unknown period of when the release date will be. The maturity date (i.e. the date on what the settlement value is calculated) is preferably decided on the generation of the instrument and would not be altered in an agreement except under extraordinary circumstances. In most jurisdictions, there is a statutory period within which a company must file financials. In some jurisdictions for example, a public company must file quarterly financials within 45 days of the quarter end. So, for an instrument transaction on a company, that's quarter ends on March 31, you might set a maturity date of May 31 (60 days after quarter end), to ensure that results were released before the Instrument transaction had to be valued. Only in rare circumstance should the maturity date have to be changed after generation (e.g. if a company announces a major delay in the release of their financial results).

The transaction features of the instrument transaction 160 can further include a transaction type, a spot price, a strike price or settlement, a percentage of the target instrument to which the transaction applies, an accounting standard to which the target instrument value will be calculated, a fixed additive value, a risk free rate and a volatility of the target instrument. The transaction type can be any type of transaction based on the underlying target instrument, for example derivatives such as futures, options, or swaps. The spot price represents the value of the target instrument as agreed upon by the parties as of the start date and interim settlement dates. At maturity, the spot price would be the actual value of the target instrument. The strike or settlement price is a price at which the instrument transaction purchaser 104 and instrument transaction seller 105 must execute the instrument transaction 160. Alternatively, in the case of options it is the price at which instrument transaction purchaser 104 has the right to execute the instrument transaction 160. The percentage of the target instrument to which the transaction applies enables the instrument transaction generation and execution system 102 to generate an instrument transaction 160 that only represents a portion or multiple of the target instrument. The accounting standard to which the target instrument value will be calculated confirms the factors that will be considered when determining the instrument value. The accounting standard can be any recognized accounting principles. Examples of such accounting standards include the international financial reporting standards (“IFRS”) and the United States generally accepted accounting principles (US GAAP). The fixed additive value can be applied to the target instrument to enable the instrument transaction generation and execution system 102 to generate and execute an instrument transaction 160 that has a negative spot price. The risk free rate is the rate of return of a hypothetical investment with no risk of financial loss. Optionally, the volatility of the target instrument can be used by the instrument transaction generation and execution system 102 to generate a premium value 154.

The instrument transaction generation and execution system 102 generates an instrument transaction by applying a set of generation rules to the target instrument and the set of transaction features. The instrument transaction 160 generated via the set of generation rules includes a set of settlement rules and a set of execution rules.

The settlement rules control how the instrument transaction generation and execution system 102 calculates the settlement value of the instrument transaction. The settlement rules identify the settlement data that must be received by the instrument transaction generation and execution system 102 to calculate the settlement value. In one embodiment, the settlement data is the value of the target instrument at the maturity date. The settlement rules can instruct the instrument transaction generation and execution system 102 to actively obtain the settlement data or to wait until the data is sent by a data provider 108 to be received by the instrument transaction generation and execution system 102. The settlement rules can specify different actions for each element of settlement data that must be obtained or received by the instrument transaction generation and execution system 102.

The settlement rules of the instrument transaction 160 further control how the instrument transaction generation and execution system 102 determines the settlement value. The settlement rules define a function that receives as input the settlement data and outputs a settlement value 150 and identifies which party (i.e. the target entity 106, the instrument transaction seller 105, or the instrument transaction purchaser 104) of the instrument transaction 160 the settlement value is to be paid to. For example, the value of the derivative at inception is a function of three things: the actual performance of the underlying asset (i.e. the target instrument), the expected performance of the underlying asset (i.e. the target instrument), and the time value of money. When the valuation period ends, the settlement value 150 is determined by the expected performance of the underlying asset (i.e. the target instrument) and the time value of money. Nothing that happens after end of the valuation period will affect the actual value of the value underlying asset. Any changes in derivative pricing is speculation. Finally, when the results for the quarter are released the price is only determined by the time value of money. These three variables (i.e. actual performance, expected performance, and time value) and their effect on the valuation of the instrument transaction 160 fall off at discrete points of time (i.e. at the valuation date, the release date, and the maturity date, respectively). This is contrary to existing derivatives where all three of these variables converge at a single point in time, the maturity date.

The execution rules of the instrument transaction 160 determine how to communicate the settlement value 150 to the parties (i.e. the target entity 106, the instrument transaction seller 105, or the instrument transaction purchaser 104) to the instrument transaction 160. The execution rules can further specify contact information to which the settlement value is to be sent (e.g. an email address, telephone number, FTP site, bank account). The execution rules can include sending the settlement value 150 via a specific format of communication such as email, telephone, a cloud based storage platform, or a specialized communication interface between the instrument transaction generation and execution system 102 and a computer system of the corresponding party. The execution rules can specify a time or time period when the settlement value 150 is to be sent to the parties or that the settlement value 150 is to be sent as soon as it is calculated by the instrument transaction generation and execution system 102.

In one embodiment, the instrument transaction 160 includes a set of interim settlement rules. The interim settlement rules identify the predictive instrument value data that must be received by the instrument transaction generation and execution system 102 to calculate the interim settlement value. The predictive instrument value data can be any of an analyst consensus value of the target instrument, a third party forecast, management forecasts of the target entity 106, the value of a related instrument associated with the target entity 106 (e.g. the stock price of the target entity 106), and/or any other instrument agreed to by the parties. The interim settlement rules can instruct the instrument transaction generation and execution system 102 to actively obtain the predictive instrument value data or to wait until the predictive instrument value data is sent by a data provider 108 to be received by the instrument transaction generation and execution system 102. The interim settlement rules can specify different actions for each element of predictive instrument value data that must be obtained or received by the instrument transaction generation and execution system 102. In such an embodiment, the release date can be known by the target entity 106 and parties other than the target entity 106 at the generation date, the release date can be unknown by the target entity 106 and parties other than the target entity 106 at the generation date, or the release date can be known by the target entity 106 at the generation date and the release date can be unknown by parties other than the target entity 106 at the generation date.

The interim settlement rules of the instrument transaction 160 further control how the instrument transaction generation and execution system 102 determines the interim settlement value 152. The settlement rules define a function that receives as input the predictive instrument value data and outputs an interim settlement value 152 and identifies which party (i.e. the instrument transaction seller 105 or the instrument transaction purchaser 104) of the instrument transaction 160 the interim settlement 152 value is to be paid to. The interim settlement value 152 can be determined as a single value determined from the predictive instrument value data. Alternatively, the interim settlement value 152 can be an arithmetic combination of more than one value from the predictive instrument value data.

In one embodiment, the execution rules of the instrument transaction 160 further determine how to communicate the interim settlement values 152 to the parties (i.e. instrument transaction seller 105 and/or the instrument transaction purchaser 104) to the instrument transaction 160. Such communication of the interim settlement values 152 can occur in a similar manner to the execution rules set out above for the communication of the settlement value 150. In one embodiment, the execution rules define a separate set of communication instructions for communicating the interim settlement value 152. In such an embodiment, the release date can be known by the target entity 106 and parties other than the target entity 106 at the generation date, the release date can be unknown by the target entity 106 and parties other than the target entity 106 at the generation date, or the release date can be known by the target entity 106 at the generation date and the release date can be unknown by parties other than the target entity 106 at the generation date.

In one embodiment, the instrument transaction 160 includes a set of premium rules. The premium rules identify the historical data 144 that must be received by the instrument transaction generation and execution system 102 to calculate the premium value 154. The historical data 144 can be the values of the target instrument over a preceding time period. Alternatively, the historical data 144 can include any metric of past performance, for example, the past performance of the target instrument, the past performance of a financial line item of the target entity 106, analyst reports of the target entity's 106 past performance, historical volatility or historical seasonality. It is understood that the historical data 144 can be any combination of the metrics of past performance. The premium rules can instruct the instrument transaction generation and execution system 102 to actively obtain the historical data or to wait until the historical data is sent by a data provider 108 to be received by the instrument transaction generation and execution system 102. The premium rules can specify different actions for each element of historical data that must be obtained or received by the instrument transaction generation and execution system 102. In such an embodiment, the release date can be known by the target entity 106 and parties other than the target entity 106 at the generation date, the release date can be unknown by the target entity 106 and parties other than the target entity 106 at the generation date, or the release date can be known by the target entity 106 at the generation date and the release date can be unknown by parties other than the target entity 106 at the generation date.

The premium rules can further identify historical instrument transactions, stored in the instrument transaction database 118, that must be received by the instrument transaction generation and execution system 102 to calculate the premium value 154.

Where there is insufficient historical data 144 and/or historical instrument transactions, the premium rules can permit a user to manually set a premium value or to modify the historical data 144 and/or historical instrument transactions provided to the instrument transaction generation and execution system 102 for the generation of the premium value.

The premium rules of the instrument transaction 160 further control how the instrument transaction generation and execution system 102 determines the premium value 154. The premium rules define a function that receives as input the historical data (and/or the historical instrument transactions) and the transaction features of the instrument transaction 160 and outputs a premium value 154. The premium value can be determined using any known method for calculating a premium value. Examples of such methods include the Black-Scholes model and running a Monte Carlo simulation and taking a weighted average profit as the premium.

The execution rules of the instrument transaction 160 can further determine how to communicate the premium value 154 to the parties (i.e. the instrument transaction seller 105 and/or the instrument transaction purchaser 104) to the instrument transaction 160. Such communication of the premium value 154 can occur in a similar manner to the execution rules set out above for the communication of the settlement value 150. In one embodiment, the execution rules define a separate set of communication instructions for communicating the premium value 154.

In one embodiment, the instrument transaction generation and execution system 102 can generate the instrument transaction 160 execution rules and send the instrument transaction 160 via the communication network 116 to a secondary market system 112. In such a case, the secondary market system 112 can operate to execute the instrument transaction on its own secondary transaction market service 114. In other words, the instrument transaction generation and execution system 102 does not take any action related to the settlement or execution of the instrument transaction 160 after it is sent to the secondary market system 112. Alternatively, the secondary market system 112 facilitates only the sale of the instrument transaction 160 to a third party and the execution of the instrument transaction 160 still occurs via the instrument transaction generation and execution system 102. In such an embodiment, the release date can be known by the target entity 106 and parties other than the target entity 106 at the generation date, the release date can be unknown by the target entity 106 and parties other than the target entity 106 at the generation date, or the release date can be known by the target entity 106 at the generation date and the release date can be unknown by parties other than the target entity 106 at the generation date.

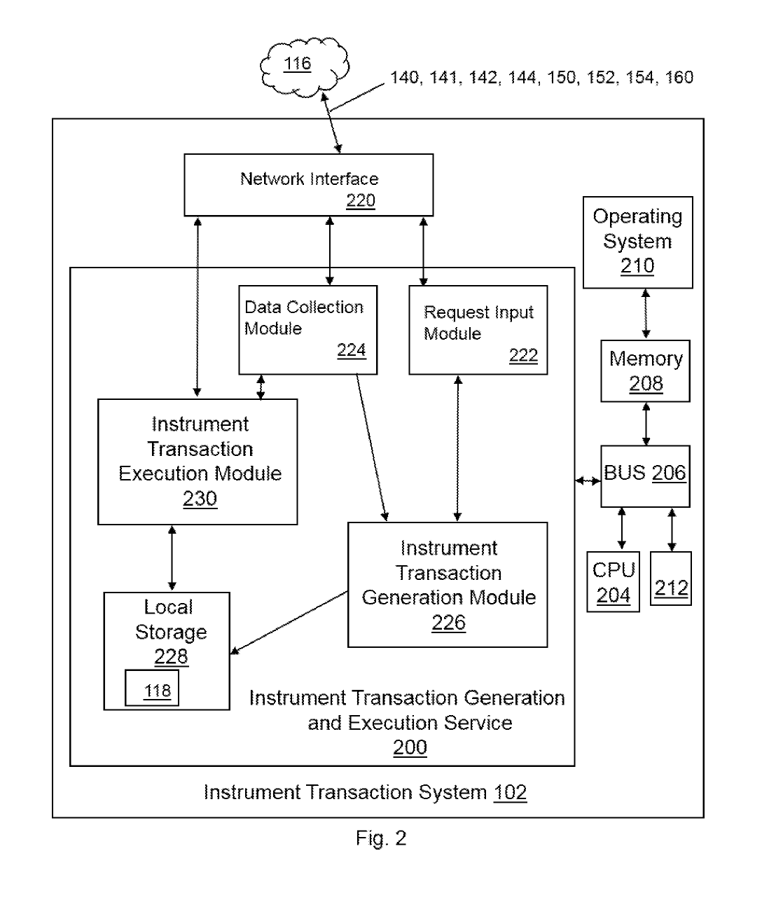

Referring to FIG. 2, the instrument transaction generation and execution system 100 for generating and executing the instrument transaction 160 has a network interface 220 that provides for communication over a network 116. The network interface 220 operates to receive from remote client systems connected to the network 116, information regarding the target instrument 140, instrument transaction generation requests 141, instrument transaction purchase requests 142, and historical data 144. In one embodiment, the network interface 220 operates to receive from the remote client system of an instrument transaction seller 105, confirmation to allow an instrument transaction purchaser 104 to purchase and instrument transaction. The network interface 220 further operates to send to remote client systems connected to the network 116, settlement values 150, interim settlement values 152, premium values 154 and instrument transactions 160. The network interface 220 communicates with the instrument transaction generation and execution service 200, the service 200 being connected to a memory 208 via a BUS 206. The service 200 is coupled to a computer processor 204 via the BUS 206, to interact with client queries (e.g. the instrument transaction generation requests 141 and the instrument transaction purchase requests 142) to monitor or otherwise instruct the operation of the instrument transaction and execution service 200 and operating system 210, in order to affect the content of the generated instrument transactions 160 and to effect the execution of the instrument transactions 160. Further, it is recognized that the instrument transaction generation and execution system 102 can include a computer readable storage medium 212 coupled to the processor 204 for providing instructions to the processor 204 and/or the service 200. The computer readable medium 212 can include hardware and/or software such as, by way of example only, magnetic disks, magnetic tape, optically readable medium such as CD/DVD ROMS, and memory cards, or future devices which serve the same function. In each case, the computer readable medium 212 can take the form of a hard disk drive, solid-state memory card, or RAM provided in the memory 208. It should be noted that the above listed example computer readable mediums 212 can be used either alone or in combination.

Referring again to FIG. 2, request input module 222 interacts with the network interface to receive the instrument transaction generation requests 141 and the instrument transaction purchase requests 142. In one embodiment, the network request input module 222 also interacts with the network interface to receive confirmation from an instrument transaction seller 105 to allow an instrument transaction purchaser 104 to purchase and instrument transaction. The data collection module 224 can interacts with the network interface to request and receive information regarding the target instrument 140 and/or historical data 144. Both request input module 222 and the data collection module 224 interact with the instrument transaction generation module 226. The instrument transaction generation module receives the instrument transaction generation requests 141 and the instrument transaction purchase requests 142 from the request input module. The instrument transaction generation module sends a request for historical data 144 to the data collection module 224. The data collection module 224 connects to the network interface 220 to submit requests for data to a third party data provider 108 over the network 116. The data collection module 224 then receives the historical data 144 sent by the third party data provider 108 over the network 116 via the network interface 220. The data collection module 224 send the historical data 144 to the instrument transaction generation module 226. The instrument transaction generation module generates an instrument transaction 160, and optionally a premium value 154, based on the instrument transaction generation request 141 or instrument transaction purchase request 142 and the historical data 144.

The instrument transaction generation and execution service 200 further comprises local storage 228 which contains an instrument transaction database 118. The instrument transaction generation module 226 interacts with the local storage 228 to store generated instrument transactions in instrument transaction database 118. The instrument transaction generation and execution service 200 includes an instrument transaction execution module 230 which interacts with data collection module 224 and the network interface 220 to request and/or receive information regarding the value of target instruments, to communicate the settlement values 150, and optionally the interim settlement values 152, of instrument transactions 160, and to communicate the premium values 154 associated with instrument transactions 160 if necessary. Instrument transaction execution module 230 interacts with the instrument transaction database 118 of the local storage 228 to receive an instrument transaction 160. The instrument transaction execution module 230 determines the settlement value 150 of the instrument transaction 160 based on the value of the target instrument received via the data collection module 224 and the network interface 220 and transmits the settlement value 150 to the network interface 220. The network interface 220 transmits the settlement value 150 to the corresponding remote client system via the network 116, which can then execute a payment of the settlement value 150.

The instrument transaction execution module 230 optionally determines one or more interim settlement value 152 of the instrument transaction 160. The instrument transaction execution module interacts with the data collection module 224 and the network interface 220 to request and/or receive predictive instrument value data from a third party data provider 108, via the communications network 116. The instrument transaction execution module 230 determines the interim instrument value of the target instrument and determines the interim settlement value 152 as a function of the strike or settlement price and the interim instrument value (the spot price). The instrument transaction execution module 230 transmits the interim settlement values 152 to the network interface 220. The network interface 220 transmits the interim settlement value 152 to the corresponding remote client system via the network 116, which can then execute a payment of the interim settlement values 152.

Where it is required by an instrument transaction 160, the instrument transaction execution module 230 determines the premium value 154 of the instrument transaction 160 based on the premium rules, the historical data and the transaction features of the instrument transaction 160 and transmits the premium value 154 to the network interface 220. The network interface 220 transmits the premium value 154 to the corresponding remote client system via the network 116, which can then execute a payment of the settlement value 154.

Accordingly, the request input module 222, data collection module 224, instrument transaction generation module 226, and instrument transaction execution module 230 collectively coordinate the generation and execution of transaction instruments 160 in response to the requests 141 and/or 142 received by the instrument transaction generation and execution system 102.

The present instrument transaction generation and execution system 102 can be used to generate and execute a derivative based on any target instrument that has a value which is unknown before a release date and such value is known after the release date.

It is preferred that the target instrument is a financial statement line item because these represent a direct method of hedging against a company's financial performance. Additionally, financial statement line items, represent different risks, obligations, strengths and weaknesses of a business and the ability to hedge or speculate on them gives the parties more control of which risk factors they want to be exposed to. In this case the value of the financial line item is unknown before the date of the reporting of the target entity's 106 financial statement at the end of an accounting period, and the value of the target instrument is known after the date of the reporting of the target entity's 106 financial statement at the end of an accounting period.

Financial statement line items include but are not limited to revenue, cost of goods sold, operating profit, selling general and admin expense, net income, EBITDA, total assets, current assets, goodwill, current liabilities, total equity, and cash flow from operations. It is understood that that a financial statement line item can be driven by non-financial results such as key performance indicators, industry operating metrics (e.g. same-store sales, load factor, backlog, etc.) and the instrument transaction 160 can define these underlying factors as the instrument. Additionally, instrument transaction 160 can be the difference, sum, product or quotient of one or more financial statement line items, non-financial results or forecasts.

Such instrument transactions 160 are fundamentally different from prior instrument transactions in that the valuation date is decoupled from the maturity date of the instrument transaction. That is, the maturity date cannot occur until the date at which the financial statement of the target entity 106 is released (i.e. the release date), the valuation date precedes the maturity date and is a date that occurs within the transaction period defined by the start date and release date of the instrument transaction 160. Derivatives taught in the prior art determine the value of the settlement on the maturity date. That is, the valuation date and maturity date were the same. However, in order to create a derivative based on a financial line item, the system must separate these two function. Financial statements must necessarily be released after the close of the time period they represent (e.g. a financial quarter). As such, it is impossible to execute an instrument transaction on the valuation date (e.g. the end of the quarter) and a system executing such an instrument transaction must decouple the valuation date and maturity date.

Furthermore, financial statements are reported only periodically, without any interim information regarding the value of a particular line item at the valuation date. The financial line item is presented only as a single value representing the value of the target instrument at a specific moment in time, the valuation date. While this valuation is provided at only a single moment in time, for values of financial line items reported on the income statement or cash flow statement it nevertheless captures the cumulative value of the financial line item (i.e. an arithmetic combination of the financial activities of the target entity 106 captured by the financial line item during the valuation period) as it was generated over the course of entire valuation period, from the start date to the valuation date, while for values of financial line items reported on the balance sheet it would represent a snapshot of the value of that financial line item at the valuation date. Unlike derivatives based on traditional assets (e.g. stocks) which are settled against the current market valuation of the asset, the instrument transactions based on financial line items can be settled based on a single reported cumulative value representing the entire period over which the instrument transaction applies.

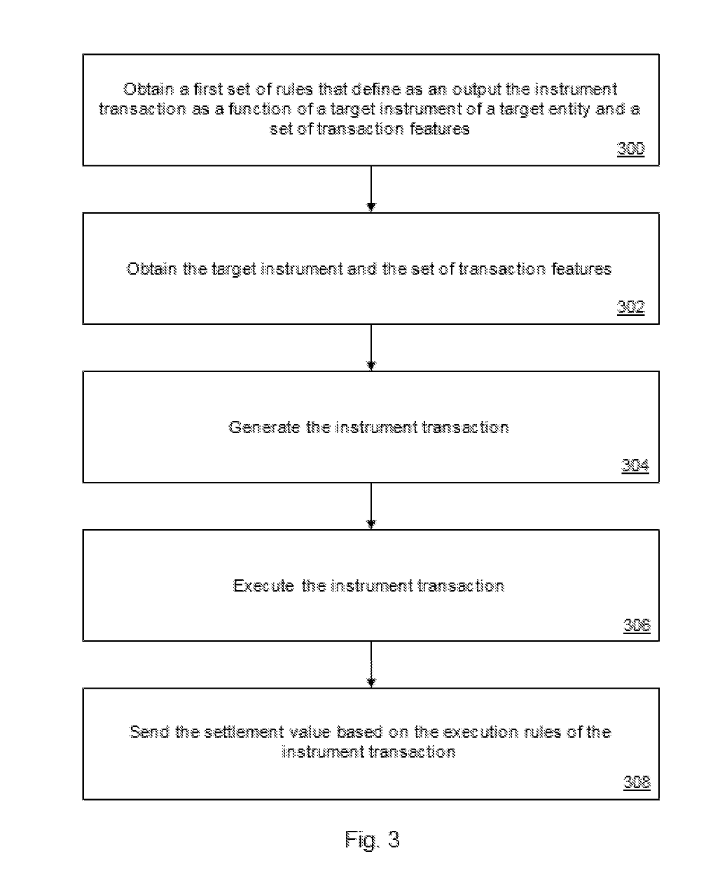

With reference to FIG. 3, at step 300 the instrument transaction generation and execution system 102 obtains a first set of rules that define as an output the instrument transaction 160 as a function of a target instrument of a target entity 106 and a set of transaction features. At step 302, the instrument transaction generation and execution system 102 obtains the target instrument and set of transaction features from an instrument transaction seller 105 or an instrument transaction purchaser 104. At step 304, the instrument transaction generation and execution system 102 generates the instrument transaction 160 by evaluating the target instrument and the set of transaction features against the first set of rules. At step 306, the instrument transaction generation and execution system 102 executes the instrument transaction 160 by applying the settlement rules of the instrument transaction to receive, on the maturity date, an instrument value of the target instrument to determine the settlement value 150 by evaluating the instrument value against the settlement rules of the instrument transaction 160. At step 308, the instrument transaction generation and execution system 102 then sends the settlement value 150 to the corresponding parties (i.e. the instrument transaction seller 105 or the instrument transaction purchaser 104) of the instrument transaction 160 based on the execution rules of the instrument transaction 160. In such an operation the release date can be known by the target entity 106 and parties other than the target entity 106 at the generation date, the release date can be unknown by the target entity 106 and parties other than the target entity 106 at the generation date, or the release date can be known by the target entity 106 at the generation date and the release date can be unknown by parties other than the target entity 106 at the generation date.

In one embodiment, the instrument transaction generation and execution system 102 can obtain at least one interim settlement date as part of the transaction features and operate to generate and execute via a computer processor 204 coupled to a memory 209 as part of the instrument transaction, interim settlement rules to, for each interim settlement date, receive predictive data of the target instrument, determine an interim instrument value 152 of the target instrument by evaluating the predictive data of the target instrument against the set of interim settlement rules of the instrument transaction 160, determine an interim settlement value by evaluating the interim instrument value of the target instrument against the interim settlement rules of the instrument transaction and send the interim settlement value 152 to the corresponding parties (i.e. the instrument transaction seller 105 or the instrument transaction purchaser 104) of the instrument transaction 160 based on the execution rules of the instrument transaction 160. In such an embodiment, the release date can be known by the target entity 106 and parties other than the target entity 106 at the generation date, the release date can be unknown by the target entity 106 and parties other than the target entity 106 at the generation date, or the release date can be known by the target entity 106 at the generation date and the release date can be unknown by parties other than the target entity 106 at the generation date.

The instrument transaction generation and execution system 102 can, where required by an instrument transaction 160, operate to generate and execute as part of the instrument transaction, premium rules to determine a premium payment via a computer processor 204 coupled to a memory 209. The premium rules define an output premium value as a function of the transaction features and historical data. The instrument transaction generation and execution system 102 obtains the historical data and generates the premium value 154 by evaluating the instrument transaction 160 and the historical data against the premium rules of the instrument transaction 160, and sends the premium value 154 to the corresponding parties (i.e. the instrument transaction seller 105 or the instrument transaction purchaser 104) of the instrument transaction 160 based on the execution rules of the instrument transaction 160.

The instrument transaction generation and execution system 102 can, in determining the settlement value 150, modify the settlement value 150 based on the difference between the maturity date and the settlement date. In doing so, the settlement value 150 can incorporate an interest value or some other value offset to account for the gap in time between the end of a quarter and the date the value of the target instrument becomes known. In other words, because the parties do not know the date the financial statement will be released (i.e. the maturity date), there may need to be a modification to the settlement value 150 based on the time between the end of quarter and the date the financial statement is actually released (i.e. the release date), the date the settlement value 150 is calculated (i.e. the maturity date), and/or the date the settlement is actually paid (i.e. the settlement date). Since the settlement date was not known at the generation of the instrument transaction 160, it could not be incorporated into the instrument transaction 160 and would need to be calculated after value of the target instrument becomes known. This can be built in at the generation of the instrument transaction 160 and would impact the settlement value 150 but would not change the terms of the contract mid-way through.

In one embodiment, the instrument transaction generation and execution system 102 can, before determining the settlement value 150 and sending the settlement value 150 to the corresponding parties (i.e. the instrument transaction seller 105 and/or the instrument transaction purchaser 104), send the instrument transaction 160 via the network 116 to a computer system of a secondary market service 112. In such an embodiment, the release date can be known by the target entity 106 and parties other than the target entity 106 at the generation date, the release date can be unknown by the target entity 106 and parties other than the target entity 106 at the generation date, or the release date can be known by the target entity 106 at the generation date and the release date can be unknown by parties other than the target entity 106 at the generation date.

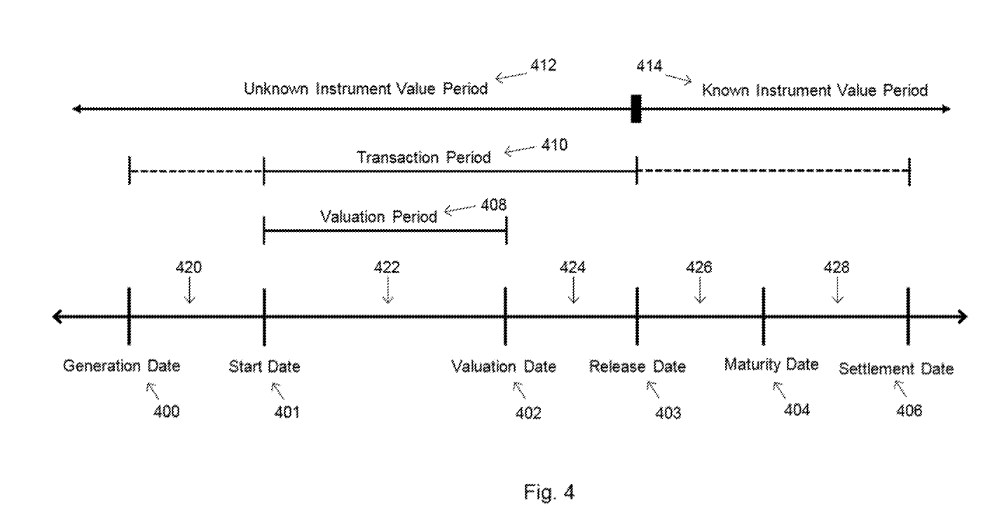

With reference to FIG. 4, the transaction features can include a set of dates, in this embodiment a generation date 400, a start date 401, a valuation date 402, a release date 403, a maturity date 404, and a settlement date 406. The generation date 400 is the date at which the parties agree to enter into the instrument transaction 160. The start date 401 is the date at which the valuation period of the target instrument of the instrument transaction 160 beings. The valuation date 402 is the date at which the value of the target instrument is determined to calculate the settlement value 150 of the instrument transaction 160. The release date 403 is the date at which the value of the target instrument on the valuation date 402 is reported and becomes known to parties other than the target entity 106. The maturity date 404 is the date at which the settlement value 150 of instrument transaction 160 is calculated. The settlement date 406 is the date at which the payment of the settlement value 150 of the instrument transaction 160 is executed by the instrument transaction generation and execution system 102.

The start date 401 can be any date before the valuation date 402 and the start date can be a date before the generation date 400. The release date 403 can be the same date as the valuation date 402 or any date thereafter. The maturity date 404 can be the same date as the valuation release date 403 or any date thereafter. The settlement date 406 can be the same date as the maturity date 404 or any date thereafter.

The start date 401 and the release date 403 define a transaction period 410. In one embodiment, the transaction period can extend to an earlier generation date 400. In a further embodiment, the transaction period can extend to a later settlement date 406. In such embodiments, and interest value can be incorporated into a settlement value 150 or premium value 154 to account for the extension of the transaction period 410 beyond the valuation period 408. The start date 401 and valuation date 402 define the valuation period which represents the period over which the instrument transaction 160 values the target instrument. The value of the target instrument on the valuation date 402 is unknown by the parties to the instrument transaction 160 other than the target entity 106 until it is reported, thus any time before the release date 403 comprises an unknown instrument value period 412 where the value of the target instrument at the valuation date 402 is unknown by the parties to the instrument transaction 160 other than the target entity 106 and any time after the release date 404 comprises a known instrument value period 414 where the value of the target instrument at the valuation date 402 is known to the parties to the instrument transaction 160.

The time period 420 between the generation date 400 and the start date 401 (the “generation-start period”), the time period 422 between the start date 401 and the valuation date 402 (the “start-valuation period”), the time period 424 between the valuation date 402 and the release date 403 (the “valuation-release period”), the time period 426 between the release date 403 and the maturity date 404 (the “release-maturity period”), and the time period 428 between the maturity date 404 and the settlement date 406 (the “maturity-settlement period”) can all be known to the parties of the instrument transaction 160 at the start date 401.

The release date 403 can be known to the parties to the instrument transaction 160 at the generation date 400. Thus, the transaction period 410, the unknown period 412, the known period 414, the valuation period 424, the release-maturity period 426, and the maturity-settlement period 428 are known to the parties to the instrument transaction 160 at the generation date 400.

Alternatively, the release date 403 can be unknown to the parties to the instrument transaction 160, at the generation date 400. Thus the transaction period 410, the unknown period 412, the known period 414, the valuation-release period 424, and the release-maturity period 426 are unknown to the parties to the instrument transaction 160 at the generation date 400.

If the release date 403 is unknown to the parties to the instrument transaction 160, the maturity date 404 is preferably known by the parties to the instrument transaction 160 at the generation date 400 and set a sufficient amount of time after the valuation date 402 to ensure the release date 403 occurs prior to the maturity date 404. In such a case, the maturity-settlement period 428 is also known by the parties to the instrument transaction 160 at the generation date 400. Alternatively, the maturity date 404 can be left undefined until the release date 403 is confirmed. In such a case the maturity-settlement period 428 is unknown to the parties to the instrument transaction 160 at the generation date 400 and remains unknown to the parties to the instrument transaction 160 until the release date 403 is confirmed.

If the release date 403 is unknown to the parties to the instrument transaction 160, the release date 403 can remain unknown to the parties to the instrument transaction 160 until the release date 403 (i.e. the target entity 106 does not determine it will report its financial statement until the release date and there is no advance notice of the reporting of the release date of target entity's 106 financial statement). Thus, the transaction period 410, the unknown period 412, the known period 414, the valuation-release period 424, the release-maturity period 426, and the maturity-settlement period 428 are unknown to the parties to the instrument transaction 160 at the generation date 400 and remain unknown to the parties to the instrument transaction 160 until the release date 403.

Alternatively, the release date 403 can be known by the target entity 106 at the generation date 400 and the release date 403 can be unknown at the generation date 400 to the parties to the instrument transaction 160 that are not the target entity 106. Thus, at the generation date 400, the transaction period 410, the unknown period 412, the known period 414, and the valuation-release period 424 are known to the target entity 106 but unknown to the parties to the instrument transaction 160 that are not the target entity 106.

If the release date 403 is known to the target entity 106 but unknown to the parties to the instrument transaction 160 that are not the target entity 160, the maturity date 404 is preferably known by the parties to the instrument transaction 160 at the generation date 400 and set a sufficient amount of time after the valuation date 402 to ensure the release date 403 occurs prior to the maturity date 404. In such a case, the release-maturity period 426 is known to the target entity 106, but not to the parties to the instrument transaction 160 that are not the target entity 106. Further, in such a case the maturity-settlement period 428 is known by the parties to the instrument transaction 160 at the generation date 400. Alternatively, the maturity date 404 can be left undefined until the release date 403 is confirmed. In such a case the maturity-settlement period 428 is unknown to the parties to the instrument transaction 160 at the generation date 400 and remains unknown to the parties to the instrument transaction 160 until the release date 403 is confirmed.

If the release date 403 is known to the target entity 106 but unknown to the parties to the instrument transaction 160 that are not the target entity 160, the release date 403 can remain unknown to the parties to the instrument transaction 160 that are not the target entity 106 until the release date 403 (i.e. the target entity 106 does not provide any advance notice of the reporting date of the target entity's 106 financial statement). Thus, at the generation date 400 the transaction period 410, the unknown period 412, the known period 414, the valuation-release period 424, the release-maturity period 426, and the maturity-settlement period 428 are known to the target entity 106 but unknown to the parties to the instrument transaction 160 that are not the target entity 106 and remain unknown to the parties to the instrument transaction 160 that are not the target entity 106 until the release date 403.

In one embodiment, the instrument transaction generation and execution system 102 can send update information to the parties (i.e. the instrument transaction seller 105 and/or the to the instrument transaction purchaser 104) of the instrument transaction 160. This update information can include the instrument transaction information 140 sent by the target entity 102 to the instrument transaction generation and execution system 102, which can include for example the release date (i.e. the date at which the target instrument value is reported) or the reported value of the target instrument at the valuation date as reported on the target entity financial statement.

Upon entering into an instrument transaction 160 generated by the instrument transaction generation and execution system 102, it is desirable for the instrument transaction seller 105 and/or the instrument transaction purchaser 104, to know the release date of the instrument transaction 160 as soon as possible after it becomes available. It is not feasible for third parties (i.e. parties that are not the target entity 106), who can be party to many instrument transactions 160, to manually track the reporting of the release date for each target entity 106 of each instrument transaction 160 to which they are a party. This presents a network challenge and in particular presents the need to route the information through the communication network 116 to inform the third parties of the update information (e.g. the release date, the instrument value) as soon as possible after it becomes available.

The instrument transaction generation and execution system 102 can facilitate the reporting of this information to the parties to an instrument transaction 160. The instrument transaction seller 104 and/or the instrument transaction purchaser 105 can request to the instrument transaction generation and execution system 102 to receive updates regarding the instrument transaction (e.g. receive an update when the release date becomes known). This request to receive updates can be submitted as part of the instrument transaction generation request 142 and/or the instrument transaction purchase request 141. Alternatively, the instrument transaction seller 104 and/or the instrument transaction purchaser 105 can submit or change their request to receive updates after they have entered into the instrument transaction 160 generated by the system 102.

The instrument transaction generation and execution system 102 receives the update information (e.g. the release date). The update information can be received from the target entity 106 or a third party service provider. The update information can be obtained by the instrument transaction generation and execution system 102 by update information sent to the system 102 once it is released, or can be actively obtained by the system 102 by polling the data source of the update information (i.e. the target entity 106 or a third party service provider).

The instrument transaction generation and execution system 102, upon receipt of the update information identifies the instrument transactions 160 stored in the instrument transaction database 118 to which the update information is relevant. The system 102 then identifies the parties (the instrument transaction seller 105 and/or the instrument transaction purchaser 104) to those instrument transactions 160 that have requested to receive updates. The system 102 sends the update information (e.g. the release date or the value of the target instrument) to the identified parties. The information can be sent to and displayed by a client application of the instrument transaction generation and execution system 102 installed on a computer system of the party. The client application can provide an option for the party to confirm receipt of the update information.

In one embodiment, the instrument transaction generation and execution system 102 can comprise a non-transitory computer readable storage medium with an executable instrument transaction generation and execution application stored thereon, the instrument transaction application configured for processing an instrument transaction update request associated with a target entity 106 computer system over a communications network, wherein the instrument transaction application instructs a computer processor to perform the following steps of: (a) receiving update information from the target entity 106, (b) identifying a subscribing party, the subscribing party having requested to receive the update information from the system 102, (c) sending output to the subscribing party, the output for presentation to the subscribing party on a user interface of a computer system of the subscribing party running a client application of the instrument transaction application in order to communicate the update information, and (d) receiving from the subscribing party, confirmation of the receipt of the update information.

The communication of the update information occurs on a specific connection, namely a network path of a communications network 116 from the target entity 106 to the instrument transaction generation and execution system 102 and then as output to the subscribing party. The present invention also includes the output sent to the subscribing party over the communications network for presentation on a user interface of their computer system. The claimed invention as a whole amounts to significantly more than simply an abstract idea and basic economic practice when viewing at least these claim features as an ordered combination. The present invention addresses the communications network challenge of informing a subscribing party of update information (e.g. the release date, the target instrument value) in a timely manner. These limitations, taken as an ordered combination, provide unconventional steps that confine the claimed invention to a particular useful application.

In one embodiment, the instrument transaction generation and execution system 102 can send confirmation information to the parties (i.e. the instrument transaction seller 105 and/or the to the instrument transaction purchaser 104) of the instrument transaction 160. This confirmation information can include confirmation of the settlement date, the settlement value 150 or any transaction features which become known after the generation of the instrument transaction 160.

Upon entering into an instrument transaction 160 generated by the instrument transaction generation and execution system 102, it is desirable for the instrument transaction seller 105 and/or the instrument transaction purchaser 104 to receive confirmation of acceptance by the other parties of transaction features (e.g. the settlement date) and/or calculated values (e.g. the settlement value 150) that are not known at the generation date of the instrument transaction 160. Performing such tasks manually is time consuming and prone to human error which can result in the confirmations not being received in a timely manner. This presents a network challenge and in particular presents the need to route the information through the communication network 116 to inform the parties to the instrument transaction 160 of confirmation of acceptance by the other parties of transaction features or calculated values that are not know at the generation date of the instrument transaction 160 as soon as possible after such confirmation becomes available.

The instrument transaction generation and execution system 102 can facilitate the communication of this confirmation to the parties to an instrument transaction 160. The instrument transaction seller 104 and/or the instrument transaction purchaser 105 can request to the instrument transaction generation and execution system 102 to receive confirmations regarding the instrument transaction from the other parties to the instrument transaction 160 when such relevant information becomes available (e.g. receive a notification when the other party confirms the settlement date and/or the settlement value). This request to receive confirmations can be submitted as part of the instrument transaction generation request 142 and/or the instrument transaction purchase request 141. Alternatively, the instrument transaction seller 104 and/or the instrument transaction purchaser 105 can submit or change their request to receive confirmations after they have entered into the instrument transaction 160 generated by the system 102.

The instrument transaction generation and execution system 102 receives the update information (e.g. the release date). The update information can be received from the target entity 106 or a third party service provider. The update information can be obtained by the instrument transaction generation and execution system 102 by update information sent to the system 102 once it is released, or can be actively obtained by the system 102 by polling the data source of the update information (i.e. the target entity 106 or a third party service provider).

The instrument transaction generation and execution system 102, upon receipt of the update information identifies the instrument transactions 160 stored in the instrument transaction database 118 to which the update information is relevant. The system 102 determines the information to be confirmed based on the update information. The system 102 then identifies the parties (the instrument transaction seller 105 and/or the instrument transaction purchaser 104) from whom confirmation is required (the “confirming party”) and the party to whom confirmation is to be sent (the “receiving party”). The system 102 sends the confirmation request to the confirming party parties. The confirmation request can be sent to and displayed by a client application of the instrument transaction generation and execution system 102 installed on a computer system of the confirming party. The client application provides an option for the confirming party to confirm acceptance of the confirmation information (e.g. the settlement date and/or the settlement value). The confirmation is sent from the confirming party to the instrument transaction generation and execution system 102. The instrument transaction generation and execution system then send a notification of the confirmation to the receiving party. The notification of the confirmation can be sent to and displayed by a client application of the instrument transaction generation and execution system 102 installed on a computer system of the receiving party.

In one embodiment, the instrument transaction generation and execution system 102 can comprise a non-transitory computer readable storage medium with an executable instrument transaction generation and execution application stored thereon, the instrument transaction application configured for processing an instrument transaction confirmation associated with a target entity 106 computer system, a confirming party computer system, and a receiving party computer system over a communications network, wherein the instrument transaction application instructs a computer processor to perform the following steps of: (a) receiving update data from the target entity 106, (b) determining confirmation information based on the update data, (c) identifying a confirming party, the confirming party required to confirm the confirmation information, (d) sending output to the confirming party, the output for presentation to the confirming party on a user interface of a computer system of the confirming party running a client application of the instrument transaction application in order to communicate the confirmation information, (e) receiving from the confirming party, confirmation of the acceptance of the confirmation information, (f) generating a notification of the received confirmation, (g) identifying a receiving party, the receiving party to receive the notification, and (h) sending a second output to the receiving party, the second output for presentation to the receiving party on a user interface of a computer system of the receiving party running a second client application of the instrument transaction application in order to communicate the notification.

The communication of the update information occurs on a specific connection, namely a network path of a communications network 116 from the target entity 106 to the instrument transaction generation and execution system 102 and then as output to the confirming party. The communication of the acceptance information further occurs on a specific connection, namely a network path of a communications network 116 from the confirming party to the instrument transaction generation and execution system 102 and then as a notification sent in output to the receiving party. The present invention also includes the output sent to the confirming party and the second output sent to the receiving party over the communications network for presentation on a user interfaces of their computer systems. The claimed invention as a whole amounts to significantly more than simply an abstract idea and basic economic practice when viewing at least these claim features as an ordered combination. The present invention addresses the communications network challenge of informing the parties to the instrument transaction 160 of confirmation of acceptance by the other parties of transaction features or calculated values that are not know at the generation date of the instrument transaction 160 as soon as possible after such confirmation becomes available. These limitations, taken as an ordered combination, provide unconventional steps that confine the claimed invention to a particular useful application.

We claim:

1. An instrument transaction system for generating and executing an instrument transaction for a target instrument between an instrument transaction seller and an instrument transaction purchaser, the target instrument having an instrument value, the instrument value being unknown before a release date and the instrument value being known after the release date, the system comprising:
a computer processor coupled to a memory, wherein the computer processor is programmed to process an instrument transaction by:
obtaining a first set of rules that define as an output the instrument transaction as a function of the target instrument of a target entity and a set of transaction features, the instrument transaction comprising a set of settlement rules and execution rules and the transaction features comprising a start date, the instrument value, and a release date wherein the start date is the date preceding the release date and the release date is the date at which the instrument value is available;
obtaining the target instrument and the set of transaction features;
generating the instrument transaction by evaluating the target instrument and the set of transaction features against the first set of rules; and
executing the instrument transaction by:
receiving the instrument value;
determining a settlement value by evaluating the instrument value against the set of settlement rules of the instrument transaction; and
sending the settlement value based on the execution rules of the instrument transaction.

2. The instrument transaction system of claim 1 wherein executing the instrument transaction further comprises:
receiving a first payment of the settlement value based on the execution rules of the instrument transaction; and
sending a second payment of the settlement value based on the execution rules of the instrument transaction.

3. The instrument transaction system of claim 1 wherein the transaction features further comprises at least one interim settlement date, the instrument transaction further comprises a set of interim settlement rules and executing the instrument transaction further comprises, for each of at least one interim settlement dates:
receiving, on the at least one interim settlement date, predictive data of the target instrument;
determining an interim instrument value of the target instrument by evaluating the predictive data of the target instrument against the set of interim settlement rules of the instrument transaction; and
determining an interim settlement value by evaluating the interim instrument value of the target instrument against the interim settlement rules of the instrument transaction; and
sending the interim settlement value based on the execution rules of the instrument transaction.

4. The instrument transaction system of claim 1 wherein executing the instrument transaction further comprises:
modifying the settlement value based on the time period between the release date and the settlement date.

5. The instrument transaction system of claim 1 wherein executing the instrument transaction further comprises:
modifying the settlement value based on the time period between the date the instrument transaction is generated and the start date.

6. The instrument transaction system of claim 1 wherein the executing the instrument transaction further comprises:
providing the instrument transaction via a network to a computer system of a secondary market service.

7. The instrument transaction system of claim 1 wherein the instrument transaction further comprises a set of premium rules that define an output premium value as a function of the target instrument, the transaction features and historical data of the target instrument, and executing the instrument transaction further comprises:
obtaining the historical data of the of the target instrument;
generating the premium value by evaluating the target instrument, the transaction features and the historical data against the set of premium rules; and
sending the premium value based on the execution rules of the instrument transaction.

8. The instrument transaction system of claim 1 wherein at least one of the target instrument and the set of transaction features is received via a network from a computer system of the instrument transaction purchaser, or the instrument transaction seller.

9. The instrument transaction system of claim 1 wherein the settlement value is sent to at least one of the instrument transaction purchaser and the instrument transaction seller.

10. The instrument transaction system of claim 1 wherein the historical data of the target instrument is received via a network from a computer system of a historical data provider.

11. The instrument transaction system of claim 1 wherein the instrument value is a cumulative value representing an arithmetic combination of financial activities of the target entity between the start date and the valuation date.

12. The instrument transaction system of claim 1 wherein the transaction features further comprise a strike price, a spot price, a percentage of the target instrument to which the transaction applies, an accounting standard, a fixed additive value to be added to the target instrument value and risk free rate.

13. The instrument transaction system of claim 12 wherein the instrument transaction further comprises a volatility of the target instrument.

14. The instrument transaction system of claim 1 wherein the release date is unknown to at least one of the instrument transaction purchaser and instrument transaction seller at the start date.

15. The instrument transaction system of claim 1 wherein the target instrument is a financial statement line item.

16. The instrument transaction system of claim 15 wherein the financial statement line item is revenue.

17. The instrument transaction system of claim 15 wherein the financial statement line item is net income.

18. The instrument transaction system of claim 15 wherein the financial statement line item is earnings before interest, taxes, depreciation and amortization (“EBITDA”).

19. The instrument transaction system of claim 15 wherein the financial statement line item is goodwill.

20. The instrument transaction system of claim 15 wherein the financial statement line item is current assets.

21. The instrument transaction system of claim 15 wherein the financial statement line item is current liabilities.

22. The instrument transaction system of claim 15 wherein the financial statement line item comprises at least one of profit, operating costs, gross income, and equity.

23. The instrument transaction of claim 1 wherein the target instrument is a key performance indicator industry or operating metric.

24. The instrument transaction system of claim 1 wherein the target instrument is the difference, sum, product or quotient of one or more financial statement line items, non-financial results, or forecasts.

25. The instrument transaction system of claim 1 wherein the transaction features further comprise a valuation date, a maturity date, and a settlement date, wherein the valuation date is the date to which the instrument value is determined, the maturity date is the date the settlement value is calculated, and the settlement date is the date the settlement value is paid.

26. The instrument transaction system of claim 7 wherein executing the instrument transaction further comprises, prior to generating the premium value, modifying the historical data of the target instrument.

27. The instrument transaction system of claim 1 wherein the instrument transaction features further comprises a valuation date, such that the valuation date precedes the release date.
